(19) United States
(12) Patent Application Publication
(10) Pub. No.: US 2016/0054435 A1
(43) Pub. Date: Feb. 25, 2016

(54) METHOD AND APPARATUS OF ADAPTIVE BEAMFORMING

(71) Applicant: GE HEALTHCARE CO., LTD., Seongnam-si (KR)

(72) Inventors: Jeong Seok KIM, Seoul (KR); Jung Gun LEE, Seongnam-si (KR)

(21) Appl. No.: 14/697,813

(22) Filed: Apr. 28, 2015

(30) Foreign Application Priority Data
Aug. 22, 2014 (KR) 10-2014-0109565

(51) Int. Cl. G01S 7/52; G10K 11/34

(52) U.S. Cl. CPC G01S 7/52046; G10K 11/34

(57) ABSTRACT

Provided is a method of adaptive beamforming, which includes calculating a correlation matrix, a first weight vector function and a noise level of received channel data, converting the correlation matrix of the channel data into a first base matrix, generating a second base matrix by selecting a base value not smaller than the calculated noise level from base values of the first base matrix, calculating a second weight vector function from the first weight vector function by using the second base matrix, and performing beam focusing by using the second weight vector function. Therefore, an image with high resolution may be obtained just with received beam focusing.

### CROSS-REFERENCE TO RELATED APPLICATIONS

This application claims priority under 35 U.S.C. §119 to Korean Patent Application No. 10-2014-0109565 filed on Aug. 22, 2014 in the Korean Intellectual Property Office, the disclosure of which is incorporated herein by reference in its entirety.

### TECHNICAL FIELD

The following disclosure relates to a method of adaptive beamforming, and in particular, to a method and apparatus of adaptive beamforming, which calculates an adaptive weight vector function by means of base value adjustment and uses the same for focusing a received beam.

### BACKGROUND

A general ultrasonic beam focusing method is composed of transmission focusing and receipt focusing according to each scan line and composes a beam-focused echo signal to implement an image. If transmission or receipt is not available like cases of obtaining an ultrahigh-speed image such as a traverse elasticity image or a photo-acoustic ultrasonic image, a scan signal is composed just with receipt focusing, which however gives seriously deteriorated image resolution.

### RELATED LITERATURES

### Patent Literature

Korean Unexamined Patent Publication No. 10-2013-0100607, entitled “apparatus and method for generating ultrasonic waves”

### SUMMARY

An embodiment of the present disclosure is directed to providing a method of adaptive beamforming, which may calculate an adaptive weight vector function by means of base value adjustment and use the same for focusing a received beam.

Another embodiment of the present disclosure is directed to providing an apparatus of adaptive beamforming, which may calculate an adaptive weight vector function by means of base value adjustment and use the same for focusing a received beam.

In an aspect of the present disclosure, there is provided a method of adaptive beamforming, which includes: calculating a correlation matrix, a first weight vector function and a noise level of received channel data; converting the correlation matrix of the channel data into a first base matrix; generating a second base matrix by selecting a base value not smaller than the calculated noise level from base values of the first base matrix; calculating a second weight vector function from the first weight vector function by using the second base matrix; and performing beam focusing by using the second weight vector function.

According to another embodiment of the present disclosure, the first weight vector function and the second weight vector function may be adaptive vector functions.

According to another embodiment of the present disclosure, the method of adaptive beamforming may further include doubly interpolating the received channel data.

According to another embodiment of the present disclosure, the beam focusing may be performed just with received beam focusing, or an ultrasonic image may be generated by means of the beam focusing.

In another aspect of the present disclosure, there is provided an apparatus of adaptive beamforming, which includes: a receiving unit for receiving channel data; a processing unit for calculating a correlation matrix, a first weight vector function and a noise level of the channel data, converting the correlation matrix of the channel data into a first base matrix, generating a second base matrix by selecting a base value not smaller than the calculated noise level from base values of the first base matrix, and calculating a second weight vector function from the first weight vector function by using the second base matrix; and a beam focusing unit for performing beam focusing by using the second weight vector function.

According to another embodiment of the present disclosure, the first weight vector function and the second weight vector function may be adaptive vector functions.

According to the present disclosure, an image with high resolution may be generated just with received beam focusing. Since a base value may decrease, the amount of operation decreases to enhance an operation rate, and an image with high SNR may be generated. In addition, the present disclosure is very useful for obtaining an ultrahigh-speed image such as a traverse elasticity image or a photo-acoustic ultrasonic image.

### BRIEF DESCRIPTION OF THE DRAWINGS

FIG. 1 is a block diagram showing an apparatus of adaptive beamforming according to an embodiment of the present disclosure.

FIG. 2 is a flowchart for illustrating a method of adaptive beamforming according to an embodiment of the present disclosure.

FIG. 3 is a flowchart for illustrating a method of adaptive beamforming according to another embodiment of the present disclosure.

FIGS. 4A, 4B, and 4C show a result according to an existing beamforming method.

FIGS. 5A, 5B, 5C, and 5D show a result according to the method of adaptive beamforming according to an embodiment of the present disclosure.

### DETAILED DESCRIPTION OF EMBODIMENTS

Prior to the explanation of the present disclosure, solutions or technical spirit of the present disclosure will be summarized or essentially proposed for convenient understanding.

A method of adaptive beamforming according to an embodiment of the present disclosure includes: calculating a correlation matrix, a first weight vector function and a noise level of received channel data; converting the correlation matrix of the channel data into a first base matrix; generating a second base matrix by selecting a base value not smaller than the calculated noise level from base values of the first base matrix; calculating a second weight vector function from the first weight vector function by using the second base matrix; and performing beam focusing by using the second weight vector function.

Hereinafter, embodiments of the present disclosure, which can be easily implemented by those skilled in the art, are described in detail with reference to the accompanying drawings. However, these embodiments are just for better understanding of the present disclosure, and it will be obvious to those skilled in the art that the scope of the present disclosure is not limited to these embodiments.

The configuration of the present disclosure will be described in detail with reference to the accompanying drawings based on the embodiments of the present disclosure to clearly understand the solutions of the present disclosure. Here, when endowing reference numerals to components depicted in the drawings, the same reference numeral is given to the same component even though this component is depicted in different drawings, and when any drawing is explained, a component depicted in another drawing may also be cited, if necessary. Moreover, when explaining an operation principle of an embodiment of the present disclosure, detailed explanation of any known function or configuration related to the present disclosure or other matters may be omitted if it may unnecessarily make the essence of the present disclosure confused.

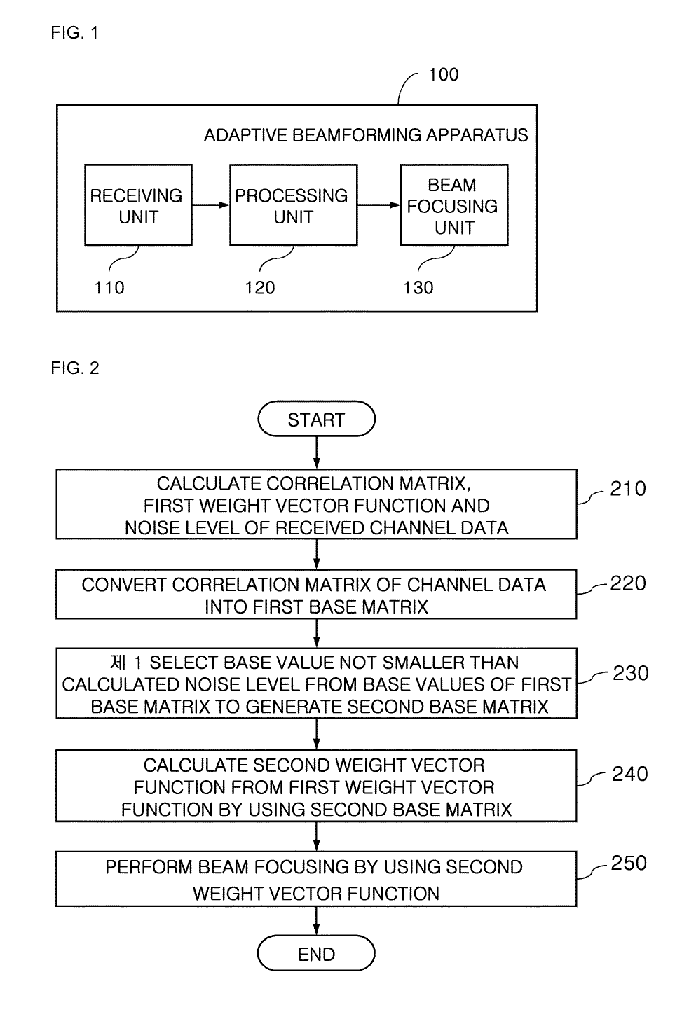

FIG. 1 is a block diagram showing an apparatus of adaptive beamforming (hereinafter, also referred to as “adaptive beamforming apparatus”) according to an embodiment of the present disclosure.

The adaptive beamforming apparatus 100 according to an embodiment of the present disclosure includes a receiving unit 110, a processing unit 120, and a beam focusing unit 130.

The receiving unit 110 receives channel data of a signal reflected from an image acquisition target from which an image is to be acquired. The received signal may be converted into channel data by means of analog-to-digital conversion.

The processing unit 120 calculates a correlation matrix, a first weight vector function and a noise level of the channel data, converts the correlation matrix of the channel data into a first base matrix, generates a second base matrix by selecting a base value not smaller than the calculated noise level from base values of the first base matrix, and calculates a second weight vector function from the first weight vector function by using the second base matrix.

In more detail, the processing unit 120 performs adaptive received beam focusing in order to focus a beam for generating a high-resolution image just by received beam focusing. For this, an adaptive weight vector function is calculated by adjusting a base value and used for the received beam focusing.

The processing unit 120 calculates a correlation matrix, a first weight vector function and a noise level of the received channel data. A time delay occurs according to a location where the channel data is received, and there is present an influence of interference or noise other than the image acquisition target. Therefore, in order to remove the influence of interference or noise, the adaptive beamforming apparatus according to an embodiment of the present disclosure uses a weight vector function. The weight vector function is a function applied to the channel data to remove the influence of interference or noise, which is a weight vector. The first weight vector function serving as the adaptive vector function is not directly applied to beam focusing, but beam focusing is performed by using a second weight vector function which is a weight vector function improved by adjusting a base value. The noise level may be calculated by evaluating a channel noise. The noise level may be calculated by checking the degree of noise included in a channel.

In order to calculate the second weight vector function, a correlation matrix, a first weight vector function and a noise level of the channel data are calculated first. The correlation matrix may be calculated by means of sample matrix inversion (SMI), loaded sample matrix inversion (LSMI) or the like. The first weight vector function may be calculated by using Lagrange's theorem. The noise level may be calculated by detecting the degree of noise included in the channel data.

The correlation matrix and the first weight vector function may be calculated as follows.

$$Z ( k ) = {\sum }_{m = 0}^{M - 1} {w}_{m} ( k ) {x}_{m} ( k ) = {W ( k )}^{H} X ( k ) . \\ \begin{matrix}P ( k ) = E [ {\vert z ( k ) \vert}^{2} ] = E [ \vert {W ( k )}^{H} R ( k ) W ( k ) \vert ] , ( R ( k ) \\ = E [ \vert X ( k ) {X ( k )}^{H} \vert ] \\ = {min}_{W ( k )} \{ {W ( k )}^{H} R ( k ) W ( k ) \} , ( {W ( k )}^{H} a = 1 ) .\end{matrix} \qquad Equation 1$$

Here, W(k) represents a weight vector function, X(k) represents an input signal vector function, Z(k) represents an output signal vector function (a received beam-focusing vector function), R(k) represents a correlation matrix vector function, P(k) represents a function for calculating an energy value by using a self-correlation value of the output signal vector function, and a vector represents a beam direction vector. At this time, a weight vector under a condition where the energy value is smallest, namely a first weight vector function W, may be obtained as follows by using Lagrange's constants.

$$∴ W = \frac{{R}^{- 1} a}{{a}^{H} {R}^{- 1} a} \qquad Equation 2$$

After the correlation matrix is calculated, this is converted into a first base matrix as follows.

$$D = \vert \begin{matrix}{λ}_{1} & & & & & \\ & {λ}_{2} & & & & \\ & & {λ}_{3} & & & \\ & & & ⋱ & & \\ & & & & ⋱ & \\ & & & & & {λ}_{L}\end{matrix} \vert \\ V = [ \begin{matrix}{V}_{1} & {V}_{2} & {V}_{3} & … & … & {V}_{L}\end{matrix} ] \qquad Equation 3$$

Here, D represents a diagonal matrix of base values, and [symbol] represents a base vector corresponding to a base value.

Among base values of the first base matrix, base values not smaller than the calculated noise level are selected to generate a second base matrix. In other words, base values smaller than the noise level are excluded, and a new base matrix, namely a second base matrix, is generated just with base values not smaller than the noise level.

A channel data noise level (N_{σ}) is measured, and a base vector (E_{S}=[ [symbol] ₁ [symbol] ₂ [symbol] ₃ . . . [symbol] _{S}]) corresponding to base values (λ_{S}≧N_{σ}) not smaller than the noise level (N_{σ}) is composed from base values (λ₁≧λ₂≧λ₃ . . . λ_{L}) of the base matrix to generate a second base matrix.

Since a base matrix is generated again by using base values not smaller than the noise level, the amount of operation may decrease to enhance an operation rate, and also a high-resolution image with high SNR may be generated. A second weight vector function is calculated from the first weight vector function by using the calculated second base matrix. In other words, the second base matrix is applied to the first weight vector function to generate the second weight vector function. The second focusing vector may be generated as follows.

∴W_{EIBMV}=E_{S}E_{S}E_{S}^{H}W_{MV} Equation 4

The beam focusing unit 130 performs beam focusing by using the second weight vector function.

As described above, a high-resolution ultrasonic image may be generated by performing only the received beam focusing, instead of transmission and receipt focusing.

FIG. 2 is a flowchart for illustrating a method of adaptive beamforming (hereinafter, also referred to as “adaptive beamforming method”) according to an embodiment of the present disclosure.

In Step 210, a correlation matrix, a first weight vector function and a noise level of channel data are calculated.

In more detail, in order to obtain a high-resolution ultrasonic image just with received beam focusing by calculating an adaptive weight vector function by adjusting a base value, a first weight vector function and a noise level of the received channel data are calculated first. Details of this step correspond to the explanation of the processing unit 120 depicted in FIG. 1 and thus refer to the detailed description about the processing unit 120 depicted in FIG. 1.

In Step 220, the correlation matrix of channel data is converted into a first base matrix.

In more detail, in order to select a base value to be adjusted, among base values of the base matrix calculated from the channel data, the correlation matrix of channel data is converted into a first base matrix. Details of this step correspond to the explanation of the processing unit 120 depicted in FIG. 1 and thus refer to the detailed description about the processing unit 120 depicted in FIG. 1.

In Step 230, a base value not smaller than the calculated noise level is selected from base values of the first base matrix to generate a second base matrix.

In more detail, a base value not smaller than the calculated noise level is selected from base values of the first base matrix to adjust a base value, and a new second base matrix is generated using the selected base value. Details of this step correspond to the explanation of the processing unit 120 depicted in FIG. 1 and thus refer to the detailed description about the processing unit 120 depicted in FIG. 1.

In Step 240, a second weight vector function is calculated from the first weight vector function by using the second base matrix.

In more detail, the second base matrix is applied to the first weight vector function to calculate the second weight vector function. Since the second weight vector function has an improved base value adjusted by the noise level in comparison to the first weight vector function, the second weight vector function is strong against noise and also allows beam focusing to generate a high-resolution ultrasonic image. Details of this step correspond to the explanation of the processing unit 120 depicted in FIG. 1 and thus refer to the detailed description about the processing unit 120 depicted in FIG. 1.

In Step 250, beam focusing is performed by using the second weight vector function.

In more detail, beam focusing is performed by using the second weight vector function calculated by adjusting a base value. The beam focusing is performed just with the received beam focusing by using the second weight vector function. Further, a high-resolution ultrasonic image may be generated by means of the beam focusing. Details of this step correspond to the explanation of the beam focusing unit 130 depicted in FIG. 1 and thus refer to the detailed description about the beam focusing unit 130 depicted in FIG. 1.

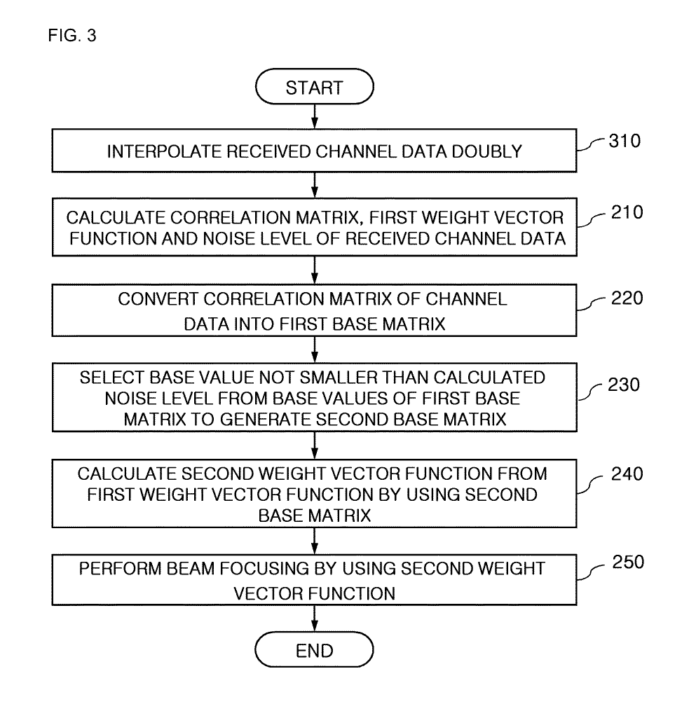

FIG. 3 is a flowchart for illustrating a method of adaptive beamforming according to another embodiment of the present disclosure.

In Step 310, the received channel data is interpolated doubly. When calculating the second weight vector function for the channel data, in order to facilitate calculation and beam focusing, the received channel data may be interpolated doubly. The beam focusing is performed by using the interpolated channel data. Details of this step correspond to the explanation of the processing unit 120 depicted in FIG. 1 and thus refer to the detailed description about the processing unit 120 depicted in FIG. 1.

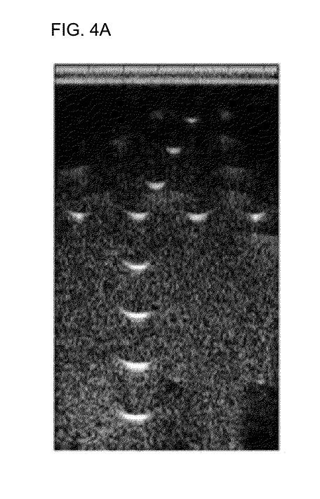

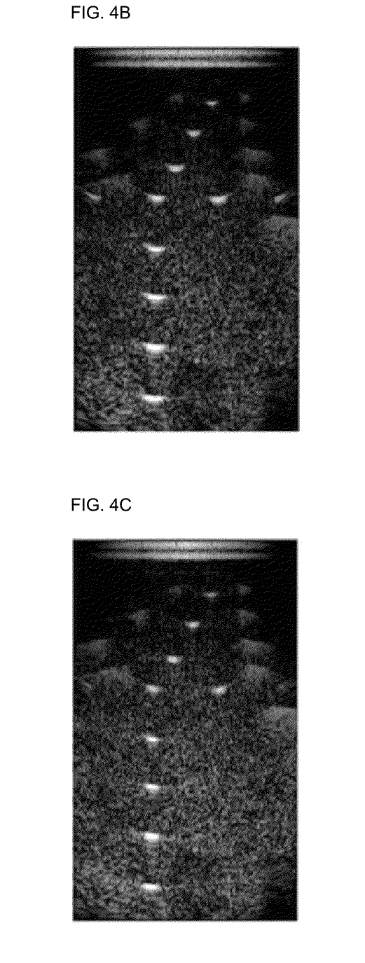

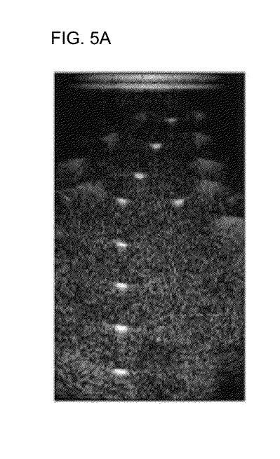

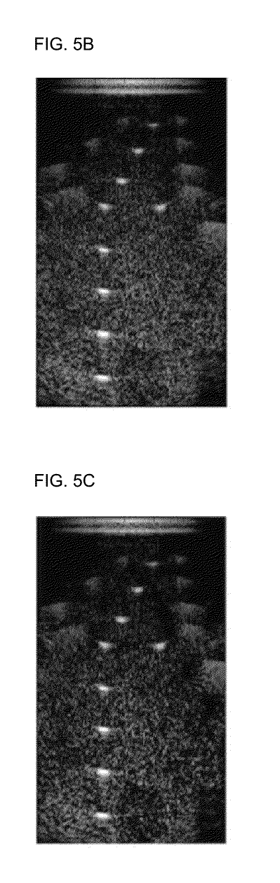

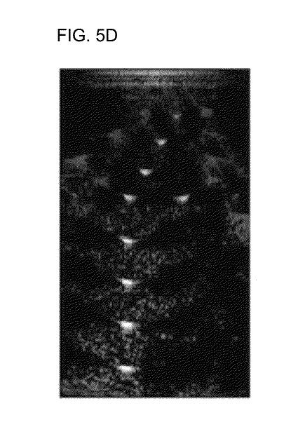

FIGS. 4A, 4B, and 4C show a result according to an existing beamforming method, and FIGS. 5A, 5B, 5C, and 5D show a result according to the method of adaptive beamforming according to an embodiment of the present disclosure.

FIGS. 4 A, 4B, and 4C show images (plane view images) generated just with receipt focusing, without transmission focusing, wherein FIG. 4A is a simple receipt receiving image, FIG. 4B is a receipt receiving image to which a weight function is applied by using a Hanning function, and FIG. 4C is a receipt receiving image to which an adaptive weight function is applied.

FIGS. 5A, 5B, 5C, and 5D show a result according to the method of adaptive beamforming according to an embodiment of the present disclosure.

FIG. 5A is a receipt receiving image to which a weight function is applied without adjusting a base value according to a noise level, and FIG. 5B to 5D are receipt receiving images resulted by using a weight vector function recalculated according to a channel noise level, to which the adaptive beamforming method according to an embodiment of the present disclosure is applied. FIG. 5B shows a result when the noise level is 48, where 49^{th} to 64^{th} base values (49^{th} to 64^{th} λ) are excluded, FIG. 5C shows a result when the noise level is 32, where 33^{rd} to 64^{th} base values (33^{rd} to 64^{th} λ) are excluded, and FIG. 5D shows a result when the noise level is 10, where 11^{th} to 64^{th} base values (11^{th} to 64^{th} λ) are excluded. It can be found that an image having a base value adjusted according to a noise level has less noise in comparison to images without base value adjustment. In addition, it can be found that the resolution of an image varies according to the calculated noise level. However, if an applied noise level is excessively great, signals may be sacrificed in addition to noise. Therefore, in order to apply an accurate noise level, a noise level of a channel should be calculated before application.

The embodiments of the present disclosure may be implemented as program commands executable by various kinds of computer means and recorded on a computer-readable recording medium. The computer-readable recording medium may include program commands, data files, data structures or the like solely or in combination. The program commands recorded on the medium may be specially designed or configured for the present disclosure or known to and available by computer software engineers. The computer-readable recording medium includes, for example, magnetic media such as a hard disk, a floppy disk and a magnetic tape, optical media such as CD-ROM and DVD, magneto-optical media such as a floptical disk, hardware devices such as ROM, RAM and a flash memory, specially configured to store and perform program commands, or the like. The program commands include not only machine codes made by a complier but also high-level language codes executable by a computer by using an interpreter. The hardware device may be configured to operate as at least one software module to perform the operations of the present disclosure, or vice versa.

While the exemplary embodiments have been shown and described, it will be understood by those skilled in the art that various changes in form and details may be made thereto without departing from the spirit and scope of this disclosure as defined by the appended claims. In addition, many modifications can be made to adapt a particular situation or material to the teachings of this disclosure without departing from the essential scope thereof.

Therefore, it is intended that this disclosure not be limited to the particular exemplary embodiments disclosed as the best mode contemplated for carrying out this disclosure, but that this disclosure will include all embodiments falling within the scope of the appended claims.

What is claimed is:

1. A method of adaptive beamforming, comprising:
calculating a correlation matrix, a first weight vector function and a noise level of received channel data;
converting the correlation matrix of the channel data into a first base matrix;
generating a second base matrix by selecting a base value not smaller than the calculated noise level from base values of the first base matrix;
calculating a second weight vector function from the first weight vector function by using the second base matrix; and
performing beam focusing by using the second weight vector function.

2. The method of adaptive beamforming according to claim 1,
wherein the first weight vector function and the second weight vector function are adaptive vector functions.

3. The method of adaptive beamforming according to claim 1, further comprising:
doubly interpolating the received channel data.

4. The method of adaptive beamforming according to claim 1,
wherein the beam focusing is performed just with received beam focusing.

5. The method of adaptive beamforming according to claim 1,
wherein an ultrasonic image is generated by means of the beam focusing.

6. A computer-readable recording medium, in which a program capable of executing the method defined in claim 1 by a computer is recorded.

7. An apparatus of adaptive beamforming, comprising:
a receiving unit for receiving channel data;
a processing unit for calculating a correlation matrix, a first weight vector function and a noise level of the channel data, converting the correlation matrix of the channel data into a first base matrix, generating a second base matrix by selecting a base value not smaller than the calculated noise level from base values of the first base matrix, and calculating a second weight vector function from the first weight vector function by using the second base matrix; and
a beam focusing unit for performing beam focusing by using the second weight vector function.

8. The apparatus of adaptive beamforming according to claim 7,
wherein the first weight vector function and the second weight vector function are adaptive vector functions.

9. The apparatus of adaptive beamforming according to claim 7,
wherein the beam focusing is performed just with received beam focusing to generate an ultrasonic image.
